(19) United States
(12) Patent Application Publication
(10) Pub. No.: US 2026/0133554 A1
(43) Pub. Date: May 14, 2026

(54) PROGRAMMING OF PROGRAMMABLE LOGIC CONTROLLERS WITH MULTIPLE TOOLS AND LANGUAGES SELECTABLE BY USER

(71) Applicant: ROCKWELL AUTOMATION TECHNOLOGIES, INC., MAYFIELD HEIGHTS, OH (US)

(72) Inventors: Ashvin K. Kudva, Mayfield Heights, OH (US); Daniel Cernohorsky, Hradec Kralove (CZ); Jeffery W. Brooks, Findlay, OH (US); Bhanu K. Gouda, Reminderville, OH (US); Brian P. Robinson, Morrisville, NC (US)

(21) Appl. No.: 19/378,124

(22) Filed: Nov. 3, 2025

Related U.S. Application Data
(60) Provisional application No. 63/720,317, filed on Nov. 14, 2024.

(51) Int. Cl. G05B 19/05

(52) U.S. Cl. CPC G05B 19/056; G05B 2219/13004

(57) ABSTRACT

Systems, industrial devices, and methods for programming of PLCs with multiple tools and languages. One method includes receiving an executable packet written in a first programming language. The method may include configuring the executable packet using a language-specific software extension such that the executable packet is executable within an execution environment of a PLC, where the language-specific software extension may be specific to the first programming language. The method may include controlling performance of an industrial process of the industrial system by executing a control application and the executable packet within the execution environment of the PLC, where the control application may be in a second programming language different from the first programming language.

### CROSS-REFERENCES TO RELATED APPLICATIONS

This claims priority to U.S. Provisional Application No. 63/720,317, filed Nov. 14, 2024, the entire contents of which is incorporated herein by reference.

### BACKGROUND

This disclosure relates to industrial environments and platforms such as industrial automation systems or manufacturing environments. Industrial manufacturing environments may include computing and mechanical systems configured to implement an industrial process. In industrial automation environments, control systems are used to drive various operations along an industrial line. Control programs are developed by programmers in integrated design applications. The integrated design applications may include programming tools to design control schemes for the industrial manufacturing environments. The control programs are used by control systems like Programmable Logic Controllers (“PLCs”) to drive the industrial assets, devices, and sensors in an industrial process. The integrated design applications communicate with numerous systems within industrial manufacturing environments like PLCs and orchestration systems. Integrated design applications may also communicate with external systems. The numerous communication links may create security vulnerabilities in the integrated design applications.

The discussion above is merely provided for general background information and is not intended to be used as an aid in determining the scope of the claimed subject matter.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

In some examples, the technology disclosed herein provides an industrial controller of an industrial system. The industrial controller may include a memory configured to store a control application to execute a first function related to an industrial process of the industrial system, where the control application may be in a first programming language that is compatible with an execution environment of the industrial controller. The industrial controller may include a processor coupled to the memory. The processor configured to receive an executable packet to execute a second function associated with the industrial process of the industrial system, where the executable packet may be in a second programming language different from the first programming language. The processor may be configured to configure the executable packet using a language-specific software extension such that the executable packet is executable within the execution environment of the industrial controller, where the language-specific software extension may be specific to the second programming language. The processor may be configured to control performance of the industrial process of the industrial system by executing the control application and the executable packet within the execution environment of the industrial controller.

In some examples, the technology disclosed herein provides a method. The method may include receiving, with an electronic processor of a programmable logic controller (PLC) of an industrial system, an executable packet written in a first programming language. The method may include configuring, with the electronic processor, the executable packet using a language-specific software extension such that the executable packet is executable within an execution environment of the PLC, where the language-specific software extension may be specific to the first programming language. The method may include controlling, with the electronic processor, performance of an industrial process of the industrial system by executing a control application and the executable packet within the execution environment of the PLC, where the control application may be in a second programming language different from the first programming language.

In some examples, the technology disclosed herein provides a non-transitory, computer-readable medium storing instructions that, when executed by one or more electronic processors, perform a set of functions. The set of functions may include receiving, at a programmable logic controller (PLC) of an industrial system, an executable packet written in a first programming language. The set of functions may include configuring, at the PLC, the executable packet using a language-specific software extension such that the executable packet is executable within an execution environment of the PLC, where the language-specific software extension may be specific to the first programming language. The set of functions may include controlling performance of an industrial process of the industrial system by executing a control application and the executable packet within the execution environment of the PLC, where the control application may be in a second programming language different from the first programming language.

The foregoing and other aspects and advantages of the present disclosure will appear from the following description. In the description, reference is made to the accompanying drawings which form a part hereof, and in which there is shown by way of illustrations one or more embodiments of the present disclosure. Such configurations do not necessarily represent the full scope of the present disclosure, however, and reference is made therefore to the claims and herein for interpreting the scope of the present disclosure.

### BRIEF DESCRIPTION OF DRAWINGS

The present disclosure will be better understood and features, aspects and advantages other than those set forth above will become apparent when consideration is given to the following detailed description thereof. Such detailed description makes reference to the following drawings.

FIG. 1 schematically illustrates a system for programming a PLC with multiple tools and languages within industrial systems according to some configurations.

FIG. 2 schematically illustrates an example industrial controller of an industrial system according to some configurations.

FIG. 3 illustrates an example workflow for programming a PLC with multiple tools and languages within industrial systems according to some configurations.

FIG. 4 schematically illustrates a user logic engine according to some configurations.

FIG. 5 schematically illustrates communication within a user logic engine according to some configurations.

FIG. 6 illustrates a flowchart of a method for programming a PLC with multiple tools and languages within industrial systems according to some configurations.

### DETAILED DESCRIPTION

As utilized herein, terms “component,” “system,” “controller,” “device,” “manager,” and variants thereof are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The disclosed technology is described with reference to the drawings, wherein like reference numerals are used to refer to like elements throughout. In the following description, for purposes of explanation, numerous specific details are set forth in order to provide a thorough understanding of the disclosed technology. It may be evident, however, that the disclosed technology may be practiced without these specific details. In other instances, well-known structures and devices are shown in block diagram form in order to facilitate describing the disclosed technology.

As noted herein, the technology disclosed herein relates generally to industrial systems, and, more particularly, to programming of PLCs with multiple tools and languages selectable by a user for industrial systems. While the technology disclosed herein is described with respect to programming of PLCs for industrial systems, the technology disclosed herein may be implemented or applied to other technologies, fields, use cases, industries, etc.

The technology disclosed herein is related to systems and methods for software defined automation (SDA), and more specifically, to SDA related to a programmable logic controller (PLC).

PLC user-programs are traditionally developed in a limited set of programming languages defined by IEC 61131 standard. Adding support for new languages involves tightly coupled changes to both PLC firmware and a proprietary IDE software. The technology disclosed herein provides an environment where additional PLC programming languages (including IEC 61131 and computer oriented languages like C++, Python) can be supported by adding extensions to PLC firmware and paring the extension with a corresponding IDE software or tooling.

For example, typically, a particular family of PLC products supports only a limited set of programming languages which are based on IEC 61131 standard. The support for this set of languages is then usually implemented as an inherent part of the core PLC functionality which is tightly connected with the other PLC capabilities. At the same time, a specialized IDE tool (typically provided by the PLC family vendor) is used to configure the PLC using the supported programming languages while the tool capabilities are tailored only for the functionality provided by the specific PLC family. Such PLC architecture makes it very difficult to extend the set of supported programming languages as modifying the core functionality of both PLC firmware and associated IDE tools is involved. The technology disclosed herein allows for extending the set of programming languages or methods which can be utilized for PLC programming.

For instance, the technology disclosed herein involves programming a PLC with multiple tools and languages selectable by an end-user. As described herein, intrinsics of a PLC (e.g., Rockwell Automation ControlLogix®) may be exported as application programming interfaces (APIs). Logix intrinsics may include, e.g., basic instructions or data building blocks of an instruction set architecture (ISA) of the PLC. For instance, an end-user may import the API(s) into technologies, languages, or an integrated development environment (IDE) by leveraging foreign function interface (FFI) technologies, such as, e.g., binding wrappers (e.g., pybind). In some instances, the end-user may then construct programs using an IDE (e.g., Visual Studio Code) that supports a mainstream programming language (e.g., Python, C++, etc.), in addition to or in replacement of IEC 61131 editors and languages traditionally used in industrial automation programming. As such, in some configurations, the technology disclosed herein may allow intermixing traditional IEC languages with modern languages to provide a hybrid environment that leverages the strengths of both IDEs. In some configurations, the program created as described above may run outside of (e.g., isolated from) the PLC that is executing the user logic or inside of the PLC executed as an additional language that the PLC supports. In some examples, in exposing the ISA, documentation and comments may be used to leverage code completion, method, and parameter information in the IDE (e.g., IntelliSense) to integrate the API(s) more seamlessly with the IDE(s) that support the user chosen languages.

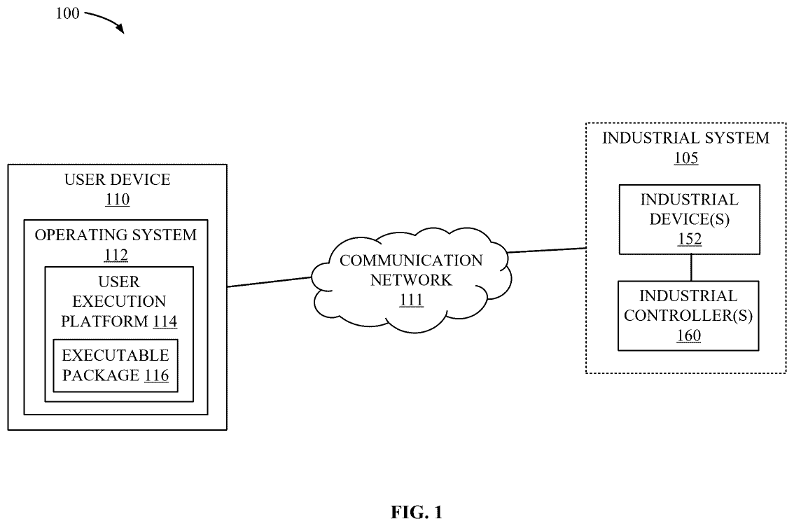

FIG. 1 schematically illustrates an example system 100 for controlling communication between one or more edge applications and a control application for industrial systems according to some configurations. In the illustrated example, the system 100 may include an industrial system 105 and a user device 110. In the example of FIG. 1, the industrial system 105 may include one or more industrial devices 152 (referred to herein collectively as “the industrial devices 152” and individually as “the industrial device 152”) and one or more industrial controllers 160 (referred to herein collectively as “the industrial controllers 160” and individually as “the industrial controller 160”), as described in greater detail herein. In some configurations, the system 100 includes fewer, additional, or different components in different configurations than illustrated in FIG. 1. As one example, the system 100 may include multiple industrial systems 105, multiple user devices 110, or a combination thereof. As another example, one or more components of the system 100 may be combined into a single device. Alternatively, or in addition, in some configurations, the user device 110 may be included as part of the industrial system 105 (e.g., as a component of the industrial system 105).

The industrial system 105 and the user device 110 may communicate over one or more wired or wireless communication networks 111. Portions of the communication networks 111 may be implemented using a wide area network, such as the Internet, a local area network, such as BLUETOOTH® or WI-FI®, and combinations or derivatives thereof. Alternatively, or in addition, in some configurations, components of the system 100 may communicate directly as compared to through the communication network 111. Also, in some configurations, the components of the system 100 may communicate through one or more intermediary devices not illustrated in FIG. 1.

The user device 110 may also include a computing device, such as a desktop computer, a laptop computer, a tablet computer, a terminal, a smart telephone, a smart television, a smart wearable, or another suitable computing device that interfaces with a user. In some examples, the user device 110 may be included as a component of the industrial system 105, such as, e.g., an HMI of the industrial system 105. However, in some configurations, such as the configuration illustrated in FIG. 1, the user device 110 may be separate or remote from the industrial system 105.

In some configurations, the user device 110 may be an industrial personal computer (PC). An industrial PC is a computing device that is specifically designed or otherwise configurated for user in industrial environments (e.g., harsh or rugged environments relative to a traditional office setting). For instance, industrial PCs may be specifically designed for continuous operation (e.g., 24/7), extreme or severe environmental conditions (e.g., temperatures, vibrations, electric noise, dust, moisture, etc.), etc. Such industrial PCs may be configured to facilitate control or operations related to an industrial process of the industrial system 105. For example, an industrial PC may perform operations or functionality related to factory automation, machine vision systems, robotics control, data logging or monitoring, etc.

As illustrated in FIG. 1, the user device 110 may include an operating system (OS) 112. The OS 112 may include a user execution platform 114. The user execution platform 114 may be used to create an executable package 116. The OS 112 can include any suitable types of processing circuitry (e.g., one or more central processing units (CPUs), one or more graphics processing units (GPUs), one or more application specific integrated circuits (ASICs), one or more field-programmable gate arrays (FPGAs), etc.) with any suitable configuration of processing cores. In some examples, the user device 110 may further include any suitable types of memory (e.g., volatile, non-volatile, random-access memory (RAM), read-only memory (ROM), electrically erasable programmable read-only memory (EEPROM), etc.).

In some examples, the user execution platform 114 may provide a user with a configurable environment for software development. In some configurations, the user execution platform 114 may be an integrated development environment (IDE), as described in greater detail herein. For example, the user execution platform 114 may include grouped project folders, configurable settings, extensions, or the like, that allow a user to develop workloads. As used herein, a workload may relate to (or otherwise include) a set of tasks or operations associated with performance of an industrial process of the industrial system 105. In some examples, the user execution platform 114 may allow a user to create the executable package 116 for a given workload. For example, the executable package 116 can include a docker image containing code, libraries, variables, etc. for running a corresponding workload. In some examples, the workload of the executable package 116 may define an application (or program) to be run with respect to the industrial system 105. In some instances, the application may be an edge application that performs an edge workload (or application) related to an industrial process of the industrial system 105. In some examples, an application may be comprised of one or more workloads, processes, or services that provide capabilities across one or more other applications. For example, the application (or edge application) may include a motion application, a vision application, a human-machine interface (HMI) application, a data gateway, a webserver, a historian application, a predictive modeling application, or the like.

Although not illustrated in FIG. 1, the user device 110 may include similar components as described herein with respect to the industrial controller 160, such as electronic processor (e.g., a microprocessor, an ASIC, or another suitable electronic device), a memory (e.g., a non-transitory, computer-readable storage medium), a communication interface, such as a transceiver, for communicating over the communication network 111 and, optionally, one or more additional communication networks or connections, and one or more HMIs. For example, to communicate with the industrial system 105 (or one or more industrial devices 152 or industrial controllers 160 thereof), the user device 110 may store a browser application or a dedicated software application executable by an electronic processor. In some configurations, the user device 110 includes additional, fewer, or different components than the industrial controller(s) 160. As noted herein, the functionality (or a portion thereof) described herein as being performed by the user device 110 may be performed by another device of the system 100, distributed among multiple devices of the system 100, combined with another component of the system 100, or a combination thereof. For example, in some configurations, the functionality (or a portion thereof) described as being performed by the user device 110 may be performed by the industrial device(s) 152, the industrial controller(s) 160, another component of the system 100 or industrial system 105, or a combination thereof.

The industrial system 105 may be a manufacturing system, such as, e.g., an industrial automation system or the like. The industrial system 105 may be associated with (or located at) a facility or site. In some configurations, a facility or site may include multiple industrial systems 105 (e.g., a first industrial system, a second industrial system, a third industrial system, etc.). Accordingly, in some configurations, the industrial system 105 may be implemented at a facility. Alternatively, or in addition, in some configurations, the system 100 may include a first industrial system located at a first facility and a second industrial system located as a second facility different from the first facility. The industrial system 105 may be configured to perform one or more industrial processes, manufacturing processes, production processes, automation processes, or the like. In some configurations, the industrial system 105 may perform a production method that produces goods or products. As one example, the industrial system 105 may perform a vehicle manufacturing process to assemble or produce a vehicle (or various components thereof). As another example, the industrial system 105 may perform a food manufacturing process for making a food product. As yet another example, the industrial system 105 may perform a pharmaceutical manufacturing process for producing pharmaceuticals.

As such, in some configurations, the industrial system 105 can be used to execute or automate manufacturing processes in industries such as, e.g., aerospace, automotive, cement, chemical processing, food and beverage, household and personal care, life sciences, marine operations, metals processing, mining operations, oil and gas, power generation, print and publishing, pulp and paper, semiconductors, warehouse and fulfillment, and wastewater treatment, among others.

In the illustrated example, the industrial system 105 may include the industrial device(s) 152. The industrial device(s) 152 may be a physical piece of equipment included in the industrial system 105. For example, an industrial device 152 may include a pump, a press, a conveyor, a valve, a switch, a motor, a motion device, a sensor, a server, a database, an HMI, another piece of equipment that may be used in connection with an associated industrial process or application of the industrial system 105, or the like.

As illustrated in FIG. 1, in some configurations, the industrial system 105 may include the industrial controller(s) 160. The industrial controller 160 may be a PLC. In some specific examples, the industrial controller 160 may be an SDA PLC (e.g., a PLC configured to implement or otherwise facilitate functions or functionality related to SDA). As described herein, the industrial controller(s) 160 may facilitate (or otherwise control) performance of an industrial process (or portion(s) thereof) with respect to the industrial system 105.

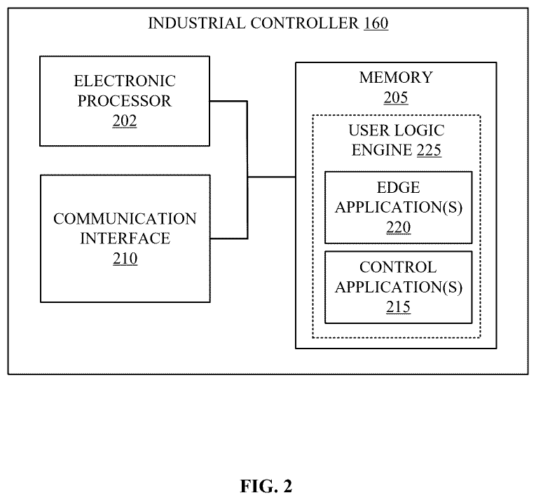

FIG. 2 illustrates an example industrial controller 160 of the industrial system 105. As illustrated in FIG. 2, the industrial controller 160 may include an electronic processor 202, a memory 205, and a communication interface 210. The electronic processor 202, the memory 205, and the communication interface 210 may communicate wirelessly, over one or more communication lines or buses, or a combination thereof. The industrial controller 160 may include additional, different, or fewer components than those illustrated in FIG. 2 in various configurations. The industrial controller 160 may also perform additional or different functionality other than the functionality described herein.

The communication interface 210 may include a transceiver that communicates with the industrial system 105 (e.g., the industrial device(s) 152 of the industrial system 105, another component or device of the industrial system 105, etc.), the user device 110, or a combination thereof over the communication network 111 and, optionally, one or more other communication networks or connections. In some configurations, the communication interface 210 enables the industrial controller 160 to communicate with the industrial system 105 (e.g., the industrial device(s) 152 of the industrial system 105), the user device 110, or a combination thereof over one or more wired or wireless connections. The electronic processor 202 may include a microprocessor, an ASIC, or another suitable electronic device for processing data, and the memory 205 includes a non-transitory, computer-readable storage medium. The electronic processor 202 is configured to retrieve instructions and data from the memory 205 and execute the instructions.

For example, as illustrated in FIG. 2, the memory 205 may include a control application 215. The control application 215 may be a control program or logic of the industrial controller 160. In some cases, the control application 215 may control (or otherwise facilitate) a real-time (or near real-time) operation of the industrial system 105 (or industrial process(es) performed thereby). For instance, the control application 215 may include one or more executable instructions that implement (or otherwise) control implementation or execution of an industrial process (or portion(s) thereof) of the industrial system 105. In some instances, the control application 215 may be in a programming language specific for industrial controllers or PLCs (e.g., a PLC programming language), such as, e.g., ladder logic, function block diagram, structured text, sequential function chart, etc. As used herein, a PLC programming language may be a programming language that is specifically tailored for industrial automation programming (e.g., programming of PLCs). For instance, a PLC programming language may be a programming language that is natively supported by industrial controllers. In some examples, a PLC programming language may be a programming language as described or based on the IEC 61131 standard.

In some examples, the control application 215 may control performance of various functions (or logic) by one or more of the industrial devices 152 (e.g., drive industrial assets, devices, or sensors in an industrial process of the industrial system 105). In some instances, the control application 215 may relate to, e.g., a monitoring process, an automation process, a data acquisition process, a sequence management process, an error detection process, a fault detection process, etc. For example, the control application 215 may include one or more operations related to the industrial device(s) 152, such as, e.g., one or more switching operations, load isolation operations, signal routing operations, torque control operations, acceleration control operations, deceleration control operations, or the like. In some instances, execution of the control application 215 (or portion(s) thereof) may involve (or otherwise include) one or more logic functions. For example, the electronic processor 202 may perform (or otherwise execute) a logic function to execute the control application 215 (or portion(s) thereof). As one example, the control application 215 may include a routine involving a sequence of logic to be executed as a block (e.g., a sequence of one or more logic functions). Following this example, to execute the control application 215, the electronic processor 202 may execute the routine by executing the sequence of logic of that routine.

As illustrated in FIG. 2, the control application 215 is included in the memory 205 of the industrial controller 160. However, in some configurations, the control application 215 (or portion(s) thereof), may be included in a separate device accessible by the industrial controller 160 (included in the industrial controller 160 or external to the industrial controller 160).

In the illustrated example of FIG. 2, in some configurations, the memory 205 may include one or more edge application(s) 220. As described herein, the edge application(s) 220 may include (or otherwise involve) computing workloads of an end-user (also referred to herein as “edge workloads”). For instance, the edge application(s) 220 may include workloads related to (or otherwise involving), e.g., motion, vision, data acquisition, human-machine interface (HMI), historian, analytics, artificial intelligence (AI) inference and machine learning, predictive modeling, autonomous mobile robot (AMR) applications, etc. As such, in some instances, the edge application(s) 220 may be an analytics application, a historian application, a data acquisition application, a motion application, an HMI application, etc. As described herein, in traditional implementations, such edge applications typically reside on edge or supplemental computing devices, such as, e.g., the user device 110, an IPC, another component or device of the industrial system 105, etc. In some instances, the edge application(s) 220 may be in a general-purpose or mainstream programming language (e.g., a programming language that is not specific to industrial automation control or programming), such as, e.g., python, C, C++, Java, JavaScript, etc. As such, in some instances, the control application 215 may be in a first programming language while the edge application(s) 220 may be in a second programming language different than the first programming language.

As illustrated in FIG. 2, in some configurations, the edge application(s) 220, the control application(s) 215, another type of executable packet, application, program, etc. may be stored within a user logic engine 225. As described in greater detail herein, in some configurations, the user logic engine 225 may facilitate (or otherwise control) interoperability between components having different programming languages. For instance, in some cases, performance of an industrial process by the industrial system 105 may involve execution of various executable packets or programs (e.g., the control application(s) 215, the edge application(s) 220, a user program, the executable packet 116, etc.), where those executable packets or programs are in different programming languages. In some cases, execution of those various executable packets or programs may include, e.g., cooperative execution (e.g., an interaction between executable packets or programs of different programming languages). As described in greater detail herein, the user logic engine 225 may facilitate (or otherwise control) seamless interoperability between components having different programming languages.

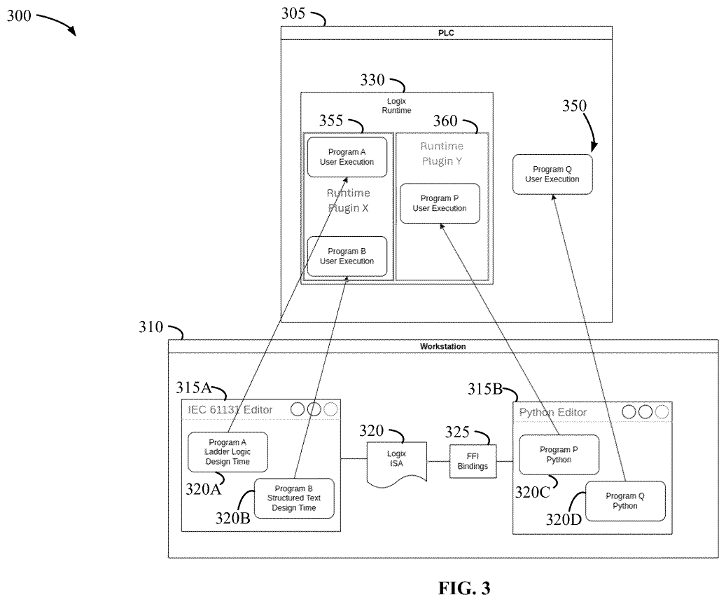

FIG. 3 illustrates an example workflow 300 according to some configurations. For instance, FIG. 3 illustrates an PLC environment 305 and an IDE environment 310. The IDE environment 310 may include one or more program editors. A program editor may be a software application or program configured to facilitate development of executable packets or programs (e.g., the executable packet(s) 116, the control program(s) 215, the edge application(s) 220, user programs, etc.), as described herein. A program editor may be specific to a particular programming language or format. In the illustrated example of FIG. 3, the program editors may include an IEC 61131 Editor (represented by reference numeral 315A) and a Python Editor (represented by reference numeral 315B). The IEC 61131 Editor 315A may be utilized to develop an executable packet or program in a PLC programming language. As such, the IEC 61131 Editor 315A may be specific to a PLC programming language. For example, as illustrated in FIG. 3, the IEC 61131 Editor 315A may be utilized to develop a first program 320A, which is in a Ladder Logic programming language, and a second program 320B, which is in a structured text programming language. The Python Editor 315B may be utilized to develop an executable packet or program in Python. For example, as illustrated in FIG. 3, the Python Editor 315B may be utilized to develop a third program 320C and a fourth program 320D, which are both in Python. As such, the Python Editor 315B may be specific to Python. As illustrated in FIG. 3, in some configurations, the IEC 61131 Editor 315A and the Python Editor may be dynamically linked via an instruction set architecture (ISA) 325 and a foreign function interface (FFI) bindings 325. In exposing the ISA 320, documentation and comments may be used to leverage code completion, method, or parameter information in the IDE environment 310 to integrate the Apl(s) more seamlessly with the IDE(s) that support the user chosen programming languages.

For instance, as illustrated in FIG. 3, intrinsics of the industrial controller(s) 160 (e.g., PLC(s)) may be exported as application programming interfaces (APIs). For example, intrinsics may include basic instructions or data building blocks of the ISA 325 for the industrial controller(s) 160. As described herein, an end-user may import the API(s) into technologies, languages, or an IDE (e.g., the IDE environment 310) by leveraging FFI technologies (e.g., the FFI bindings 325), such as, e g., binding wrappers (e.g., pybind). As illustrated in FIG. 3, the end-user may the construct programs using an IDE (e.g., Visual Studio Code) that supports a mainstream programming language (e.g., Python), in addition to or in replacement of IEC 61131 editors and languages traditionally used in industrial automation programming (e.g., the IEC 61131 Editor 315A, the Python Editor 315B, etc.). As described herein, the technology disclosed herein allows intermixing traditional IEC languages with modern languages to provide a hybrid environment that leverages the strengths of both IDEs, as illustrated in FIG. 3.

As illustrated in the example of FIG. 3, in some configurations, an executable packet or program may be implemented (e.g., run or executed) via a runtime environment 330 of the industrial controller 160 (e.g., within a firmware of the PLC). In such configurations, the executable packet or program may be implemented as a PLC user program. For example, as illustrated in FIG. 3, the first program 320A, the second program 320B, and the third program 320C may be implemented within the runtime environment 330 of the industrial controller 160. Alternatively, or in addition, in some configurations, the executable packet or program may be implemented (e.g., run or executed) outside of the runtime environment 330 of the industrial controller 160 (e.g., as an independent computer program). For example, as illustrated in FIG. 3, the fourth program 320D may be implemented as an independent computer program within an execution environment of the industrial controller 160 (represented in FIG. 3 by reference numeral 350).

In some configurations, an executable packet or program deployed within the runtime environment 330 may be processed within a context of a particular language specific plug-in (e.g., a language-specific software extension or plug-in). In such instances, the language-specific software extension may be configured to process or otherwise interpret an artifact (e.g., a machine executable artifact) of a corresponding executable packet or program. An artifact (or a machine executable artifact) may include (or otherwise be associated with) the corresponding executable packet or program. For example, the language-specific software extension may be configured to link and launch (or execute) the executable packet or program (e.g., via interaction with the machine executable artifact).

As used herein, a software extension or a plug-in may be a software component (or executable instructions) that adds specific features or functionalities to an existing computer program or application. In some examples, the software extension or plug-in may allow a user to customize software based on a particular objective or task of the user. As one example, the language-specific software extension or plug-in may be utilized to dynamically add support (or functionality) related to a particular programming language, such as, e.g., a programming language that is not natively supported by the industrial controller 160.

In the example of FIG. 3, the runtime environment 330 may include a first runtime plug-in 355 (e.g., a first language-specific software extension) that is specific to a PLC programming language. The runtime environment 330 may include a second runtime plug-in 360 (e.g., a second language-specific software extension) that is specific to Python. In some configurations, the language-specific software extension(s) may be implemented as independent components having well-defined API(s), which can be added or removed to or from the runtime environment 330 without impacting other capabilities or functionality of the industrial controller 160 (e.g., such as core PLC functions).

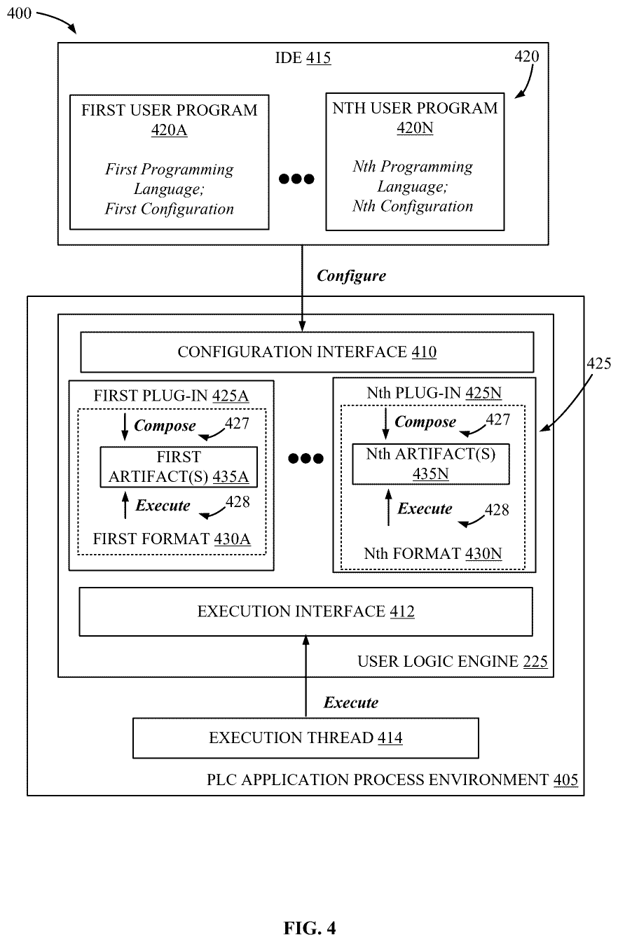

FIG. 4 schematically illustrates the user logic engine 225 according to some configurations. As illustrated in FIG. 4, the user logic engine 225 may be implemented within a PLC application process environment 405. In some cases, the user logic engine 225 may be instantiated as a separate process or placed within another process running on the industrial controller 160 (e.g., a Logix IEC Control process). The user logic engine 225 may support plug-in modules (e.g., language-specific software extensions or plug-ins) to configure and execute user logic (e.g., the executable packet(s) 116, the edge application(s) 220, user programs or applications, etc.), which may be represented in different formats (as appropriate to the programming language in which the user logic is written).

The user logic engine 225 may include one or more interfaces for interacting with components external to the user logic engine 225. In the example of FIG. 4, the user logic engine 225 may include a configuration interface 410 and an execution interface 412. In some configurations, the configuration interface 410, the execution interface 412, or a combination thereof may be implemented as an API (e.g., a configuration API).

As illustrated in FIG. 4, the execution interface 412 may facilitate communication between the user logic engine 225 and an execution thread 414 of the PLC application process environment 405, as illustrated in FIG. 4. Accordingly, in some configurations, the execution interface 412 may be implemented with respect to execution operations (e.g., executing user programs or artifacts thereof), as described herein.

The configuration interface 410 may facilitate communication between the user logic engine 225 and an IDE 415 (e.g., the user execution platform 114 of FIG. 1, the IDE environment 310 of FIG. 3, etc.). The communication facilitated via the configuration interface 410 may relate to configuring one or more user programs 420 (e.g., the executable packet(s) 116, the edge application(s) 220, etc.). For example, as illustrated in FIG. 4, the user programs 420 may include a first user program 420A and an Nth user program 420N. In some configurations, the user programs 420 may be written in different programming languages.

Accordingly, in some configurations, the configuration interface 410, the execution interface 412, or a combination thereof may allow the user logic engine 225 to transparently configure and execute runnable artifacts (or machine executable artifacts) (e.g., a IEC program or routine, a C++ executable, a python module, etc.).

For instance, in some configurations, the user programs 420 may be received via the configuration interface 410. Responsive to receipt of the user programs 420, the user program(s) 420 may be provided to one or more plug-ins 425 (e.g., a first plug-in 425A and an Nth plug-in 425N, as illustrated in FIG. 4). As described herein, the plug-ins 425 (e.g., the language-specific software extensions) may be programming language specific. Accordingly, the first plug-in 425A may be specific to a first programming language while the Nth plug-in 425N may be specific to an Nth programming language. Following the example of FIG. 4, the first user program 420A may be provided to the first plug-in 425A, as the first plug-in 425A is specific to the first programming language of the first user program 420A. Similarly, the Nth user program 420N may be provided to the Nth plug-in 425N, as the Nth plug-in 425N is specific to the Nth programming language of the Nth user program 420N.

The plug-in(s) 425 may configure the user program(s) 420, as described herein. For instance, in some configurations, the plug-in(s) 425 may compose (or otherwise generate) one or more artifacts (e.g., one or more machine executable artifacts) for each of the user programs (represented in FIG. 4 by reference numeral 427). As described herein, a machine executable artifact may include, e.g., a IEC program or routine, a C++ executable, a python module, etc. The plug-in(s) 425 may also execute (or otherwise run) the one or more artifacts (represented in FIG. 4 by reference numeral 428).

Accordingly, in some configurations, the user logic engine 225 may support plugin modules to configure and execute user logic, which can be represented in different formats (as appropriate to the programming language in which the logic is written). For instance, as illustrated in FIG. 4, the first plug-in 425A may be associated with a first format 430A and the Nth plug-in 425N may be associated with a second format 430N. In some configurations, a number of plugin modules (e.g., the plug-in(s) 425) may be transparently modified or extended without changes to a core Engine (e.g., a core functionality of the industrial controller 160).

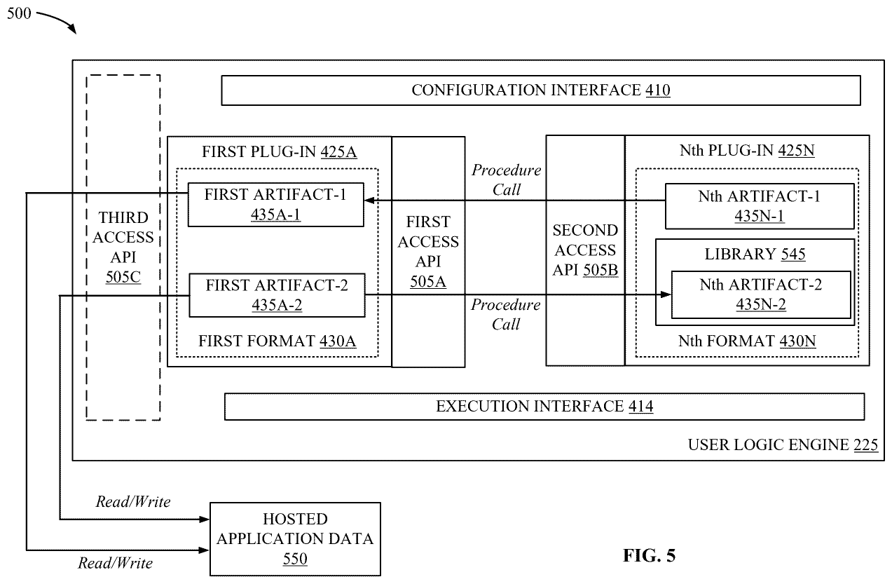

FIG. 5 illustrates an example workflow 500 of communication between the plug-in(s) 425, in accordance with some configurations. As illustrated in FIG. 5, in some configurations, the user logic engine 225 may include one or more access APIs. For example, the user logic engine 225 may include a first access API 505A associated with the first plug-in 425A and a second access API 505B associated with the Nth plug-in 425N. As illustrated in FIG. 4, the first access API 505A and the second access API 505B may facilitate communication (or interaction) between the first plug-in 425A (e.g., a first artifact-1 435A-1 or a first artifact-2 435A-2 thereof) and the Nth plug-in 425N (e.g., a Nth artifact-1 435N-1 or a Nth artifact-2 435N-2 thereof). In some configurations, a machine executable artifact may be implemented within a library 545 (e.g., as illustrated with respect to the Nth artifact-2 435N-2 of FIG. 5). As illustrated in FIG. 5, communication between the first plug-in 425A and the Nth plug-in 425N may include one or more procedure calls.

As used herein, a procedure call may refer to an instruction that causes (or otherwise results in) invoking or executing a set of executable instructions, such as, e.g., a procedure, a function, a routine, a subroutine, etc. As one example, a procedure call may be a remote procedure call (RPC) to another process, function, routine, etc., such as, e.g., a process written in a PLC programming language or a different programming language. As another example, a procedure call may be a Jump to SubRoutine (JSR) instruction or call (e.g., an instruction to jump to another part of a computer program or application).

As illustrated in FIG. 5, the user logic engine 225 may include a third access API 505C. The third access API 505C may be associated with the first plug-in 425A. The third access API 505A may facilitate communication (or interaction) between the first plug-in 425A and hosted application data 550 (e.g., access to public data within an application hosting the user logic engine 225). As illustrated in FIG. 4, such communication (or interaction) may include one or more read operations, write operations, or read/write operations.

Accordingly, in some configurations, the user logic engine 200 may provide one or more access APIs, which may allow or otherwise facilitate a plugin module to provide their own implementation for: (a) invoking procedures in runnable artifacts from other plugins; (b) accessing public data within an application hosting the user logic engine 225; etc.

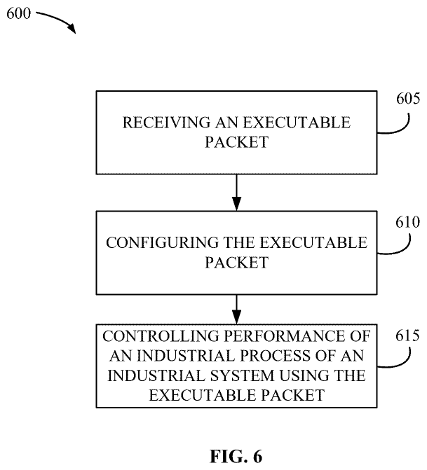

FIG. 6 is a flowchart illustrating a method 600 for programming of PLCs with multiple tools and languages according to some configurations. The method 600 is described as being performed by industrial controller 160 (e.g., the electronic processor 202 executing the user logic engine 225, as described herein). However, as noted herein, the functionality described with respect to the method 400 may be performed by other devices, such as the industrial device(s) 152, the user device 110, another industrial device, another component included in the industrial system 105, or a combination thereof, distributed among a plurality of devices, such as a plurality of servers included in a cloud service, or a combination thereof. As described below, a particular implementation can omit some or all illustrated features/steps, may be implemented in some embodiments in a different order, and may not involve some illustrated features to implement all embodiments.

As illustrated in FIG. 6, the industrial controller 160 may receive an executable packet written in a first programming language (at block 605). As described herein, the executable packet (e.g., the executable packet 116, the edge application(s) 220, user programs or applications, etc.) may be developed using an IDE (e.g., the IDE 415 of FIG. 4). The executable packet may be received as described herein. As one example, the executable packet may be received via the configuration interface 410 of the user logic engine 225, as described in greater detail herein.

The industrial controller 160 may configure the executable packet (at block 610). In some configurations, the industrial controller 160 (e.g., via the user logic engine 225) may use a language-specific software extension (e.g., the plug-in(s) 425). As described in greater detail herein, configuring the executable packet (e.g., via a compose operation of the plug-in(s) 425, as described herein) may facilitate (or otherwise allow) the executable packet to be executable within an execution environment of the industrial controller 160. The language-specific software extension utilized to configure the executable packet may be specific to a programming language of the executable packet, as described herein. In some configurations, the industrial controller 160 (e.g., via the user logic engine 225) may configure the executable packet by generating one or more machine executable artifacts based on (or otherwise related to) the executable packet and storing the machine executable artifact(s) within the language-specific software extension (e.g., the plug-in(s) 425), as described herein.

The industrial controller 160 (e.g., via the user logic engine 225) may control performance of an industrial process of the industrial system 105 (at block 615). In some configurations, the industrial controller 160 may control performance of the industrial process by executing one or more executable packets or programs (e.g., performing one or more execute operations on machine executable artifacts 435), as described herein. In some examples, controlling performance of an industrial process of the industrial system 105 may include executing multiple executable packets. As one example, the industrial controller 160 may control performance of an industrial process of the industrial system 105 by executing a user program (or logic) and the control application 215.

In some configurations, performance of the industrial process may include an interaction between executable packets (or machine executable artifacts thereof). As one example, performance of the industrial process may include an interaction between the control application 215 and a user program (or executable packet). As one specific example, in some cases, an interaction between executable packets may include a procedure call, such as, e.g., a procedure call transmitted between plug-in modules (e.g., the first plug-in 425A and the Nth plug-in 425N), between the control application 215 and a plug-in module, etc. Alternatively, or in addition, in some configurations, performance of the industrial process may include executing a read operation, a write operation, or a read/write operation with respect to various executable packets (e.g., the control application 215, the edge application(s) 220, user programs or logic, etc.).

What has been described above includes examples of the disclosed technology. It is, of course, not possible to describe every conceivable combination of components or methodologies for purposes of describing the disclosed technology, but one of ordinary skill in the art may recognize that many further combinations and permutations of the disclosed technology are possible. Accordingly, the disclosed technology is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed technology. In this regard, it will also be recognized that the disclosed technology includes a system as well as a computer-readable medium having computer-executable instructions for performing the acts and/or events of the various methods of the disclosed technology.

In addition, while a particular feature of the disclosed technology may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. An industrial controller of an industrial system, the industrial controller comprising:
a memory configured to store:
a control application to execute a first function related to an industrial process of the industrial system, wherein the control application is in a first programming language that is compatible with an execution environment of the industrial controller; and
a processor coupled to the memory, the processor configured to:
receive an executable packet to execute a second function associated with the industrial process of the industrial system, wherein the executable packet is in a second programming language different from the first programming language;
configure the executable packet using a language-specific software extension such that the executable packet is executable within the execution environment of the industrial controller, wherein the language-specific software extension is specific to the second programming language; and
control performance of the industrial process of the industrial system by executing the control application and the executable packet within the execution environment of the industrial controller.

2. The industrial controller of claim 1, wherein the industrial controller is a programmable logic controller (PLC).

3. The industrial controller of claim 1, wherein the language-specific software extension is a plug-in.

4. The industrial controller of claim 1, wherein the first programming language is a PLC programming language that is specific to industrial control.

5. The industrial controller of claim 1, wherein the first programming language includes at least one of: ladder logic; function block diagram; sequential function charts; or structured text.

6. The industrial controller of claim 1, wherein the second programming language is not natively supported by the industrial controller.

7. The industrial controller of claim 1, wherein the language-specific software extension is installed on the industrial controller.

8. The industrial controller of claim 1, wherein the executable packet includes at least one of: a user program; or a library.

9. The industrial controller of claim 1, wherein performance of the industrial process includes an interaction between the control application and the executable packet.

10. The industrial controller of claim 9, wherein the interaction includes a procedure call transmitted between the control application and the executable packet.

11. The industrial controller of claim 1, wherein performance of the industrial process includes executing a read or write operation with respect to at least one of: the control application; or the executable packet.

12. A method, comprising:
receiving, with an electronic processor of a programmable logic controller (PLC) of an industrial system, an executable packet written in a first programming language;
configuring, with the electronic processor, the executable packet using a language-specific software extension such that the executable packet is executable within an execution environment of the PLC, wherein the language-specific software extension is specific to the first programming language; and
controlling, with the electronic processor, performance of an industrial process of the industrial system by executing a control application and the executable packet within the execution environment of the PLC, wherein the control application is in a second programming language different from the first programming language.

13. The method of claim 12, wherein configuring, with the electronic processor, the executable packet includes:
generating at least one machine executable artifact; and
storing the at least one machine executable artifact within the language-specific software extension.

14. The method of claim 13, wherein executing the executable packet includes:
accessing the at least one machine executable artifact using an application programming interface (API) of the language-specific software extension.

15. The method of claim 12, wherein controlling, with the electronic processor, the performance of the industrial process of the industrial system includes:
executing a procedure call between the control application and the executable packet.

16. The method of claim 12, wherein receiving, with the electronic processor, the executable packet includes receiving, with the electronic processor, the executable packet from an integrated development environment (IDE).

17. A non-transitory, computer-readable medium storing instructions that, when executed by one or more electronic processors, perform a set of functions, the set of functions comprising:
receiving, at a programmable logic controller (PLC) of an industrial system, an executable packet written in a first programming language;
configuring, at the PLC, the executable packet using a language-specific software extension such that the executable packet is executable within an execution environment of the PLC, wherein the language-specific software extension is specific to the first programming language; and
controlling performance of an industrial process of the industrial system by executing a control application and the executable packet within the execution environment of the PLC, wherein the control application is in a second programming language different from the first programming language.

18. The computer-readable medium of claim 17, wherein the language-specific software extension is stored in a firmware of the PLC.

19. The computer-readable medium of claim 17, wherein receiving the executable packet includes receiving at least one of: a user program; or a library.

20. The computer-readable medium of claim 17, wherein controlling performance of the industrial process includes an interaction between the control application and the executable packet.
